(19) United States
(12) Patent Application Publication
(10) Pub. No.: US 2021/0069701 A1
(43) Pub. Date: Mar. 11, 2021

(54) OPERATION OF MAGNETIC BEADS ON MICROFLUIDICS SUBSTRATES

(71) Applicant: BGI Shenzhen Co., Ltd., Shenzhen (CN)

(72) Inventors: Jian Gong, Danville, CA (US); Yan-You Lin, Fremont, CA (US); Sz-Chin Lin, San Jose, CA (US); Cheng Frank Zhong, Menlo Park, CA (US)

(21) Appl. No.: 17/015,962

(22) Filed: Sep. 9, 2020

Related U.S. Application Data
(60) Provisional application No. 62/898,454, filed on Sep. 10, 2019.

(51) Int. Cl. B01L 3/00

(52) U.S. Cl. CPC B01L 3/50273; B01L 2300/0864; B01L 2400/043; B01L 3/502761

(57) ABSTRACT

Embodiments of the disclosure include methods and apparatuses for separating beads from a droplet main body on a microfluidics actuator by applying a magnetic field to a droplet disposed at a first location, the droplet including one or more magnetically responsive beads; and moving the magnetic field to separate the one or more magnetically responsive beads from a main body of the droplet. Embodiments also include methods and apparatuses for introducing one or more beads into a droplet main body by applying a magnetic field to one or more magnetically responsive beads and moving the magnetic field to introduce the one or more magnetically responsive beads into a droplet disposed on a first location, wherein the droplet includes a fluid.

### CROSS-REFERENCES TO RELATED APPLICATIONS

This application claims priority to U.S. Provisional Patent Application No. 62/898,454, filed Sep. 10, 2019, the content of which is incorporated in its entirety herein by reference.

### RELATED FIELDS

Apparatuses and methods for manipulating beads, and in particular, manipulating magnetically responsive beads on a microactuator.

### BACKGROUND

Electrowetting-on-dielectric (EWOD) is a liquid driving mechanism to change a contact angle of an aqueous droplet between two electrodes on a hydrophobic surface. This is done by modifying the hydrophobicity of the surface using an electric field. For example, applying a voltage may modify the surface such that it switches from a hydrophobic state to a hydrophilic state. A bulk liquid droplet as large as several millimeters (i.e., several microliters in volume) can be moved by an array of electrodes disposed on a substrate, such as an inorganic substrate (e.g., silicon/glass substrate) or organic substrate (e.g., a cyclic olefin polymer/polycarbonate substrate).

A microfluidics actuator (or “microactuator”) is a device that may be used to manipulate droplets of a very small size. Microactuators are usefully employed in many biological assay workflow such as next generation DNA/RNA sequencing library preparation. Such workflows typically capture targets such as DNA, RNA, or antibodies using beads, and employ the beads as carriers to transport targets to desired locations on the microfluidics actuator and/or effectuate one or more reactions.

### BRIEF SUMMARY

This disclosure presents apparatuses, systems, and methods for manipulating beads on a microactuator. In some embodiments, the beads may be magnetically responsive such that they may be moved or otherwise manipulated using a magnetic field. In some embodiments, the beads may be bound to targets such as DNA molecules, RNA molecules, or antibodies, and may thus be used as a means for manipulating these targets. For example, beads bound to target DNA molecules may be moved in and out of droplets in a microactuator, where the droplets may contain reagents to effectuate reactions within the droplets. Conventional methods of moving beads in and out of droplets involved immobilizing beads and then using electrowetting to move a droplet toward the beads or away from the beads, respectively. Such methods are laden with several disadvantages. For example, using electrowetting requires the application of a relatively high voltage (e.g., 300 V) across a dielectric surface of the microactuator, especially when it is done to move droplets away from beads. In some cases, these voltages may be higher than the voltages required for merely transporting droplets, which may be 150 V to 200 V. Repeatedly applying high voltages may result in damage to the microactuator. For example it may cause dielectric breakdown, where ions or other impurities may be introduced into the dielectric and may consequently cause the dielectric to become a conductor. Once the dielectric becomes a conductor, the microactuator may be rendered ineffective (e.g., applying a voltage to such a dielectric may cause droplets within the microactuator to be localized) and may consequently require replacement. Another disadvantage is that moving a droplet away from beads using electrowetting often leaves behind an appreciable number of beads within the droplet body that was moved away from the beads and/or leaves behind an appreciable amount of residual fluid from the droplet with the beads. This is in part due to the imprecise nature of the electrowetting approach. For example, the electrowetting approach induces a flow that is significant enough to drag beads along with the fluid of the droplet. Furthermore, the electrowetting approach does not allow for fine-tuned control of the flow rate, resulting in an unnecessary amount of residual fluid being left with the beads.

Embodiments of the present disclosure break from the conventional methods described above by magnetically moving beads in and out of droplets. In some embodiments, the disclosed methods may be performed while the droplets themselves remain stationary. The methods described by the present disclosure may provide one or more of the following advantages over conventional methods. First, since electrowetting is not required to move beads in and out of droplets, the risk of dielectric breakdown is reduced significantly. Second, magnetically moving beads is far more precise and controllable. The beads are concentrated in an area abutting a substrate of the microactuator and can be moved at any desired rate. The fine-tuned control of this rate is limited only by the level of control of the magnetic field (e.g., a motion of a permanent magnet generating the magnetic field), which is far more precise and controllable than the flow resulting from electrowetting. Finally, the magnetic bead transport techniques described herein may also be applied in applications that do not require electrowetting. For example, magnetic beads may be used within microfluidics cartridges that rely on other methods of fluid transport (e.g., continuous-flow microfluidics, paper-based microfluidics, thread-based microfluidics). It is noted that these are only examples of advantages. Other advantages may become readily apparent in light of the disclosure.

In some embodiments, a method may include applying a spot magnetic field to a droplet disposed at a first location on a first surface of a microactuator, the droplet including one or more magnetically responsive beads and a fluid; and moving the spot magnetic field to separate one or more magnetically responsive beads from a main body of the droplet. In some embodiments, one or more magnetically responsive beads may include a set of magnetically responsive beads (e.g., two or more beads). In some embodiments, applying the spot magnetic field to the droplet may concentrate at least some of the set of magnetically responsive beads into a bead pallet (e.g., which may include a cluster of beads), and moving the spot magnetic field may include separating the bead pallet from the main body of the droplet by, for example, moving a source of the spot magnetic field (e.g., one or more permanent magnets, one or more electromagnets) toward the first location. In some embodiments, the bead pallet may further include a residual volume of fluid. In some embodiments, moving the spot magnetic field to separate the bead pallet from the main body of the droplet may include moving the source of the spot magnetic field along the first surface (e.g., substantially parallel to a plane defined by the first surface) of the microactuator, and moving the spot magnetic field may move the bead pallet to a second location on the first surface. In some embodiments, the magnetic field source (e.g., a magnet) may be movable both (1) toward and away from the first substrate and (2) along the first substrate. For example, the magnetic field source may be movable along a trajectory defined at least in part by a vector perpendicular to a plane defined by the first substrate and further movable along a trajectory defined at least in part by a vector parallel to the plane defined by the first substrate.

In some embodiments, the microactuator may include a first substrate. The first substrate may include the first surface and a second surface that opposes the first surface. In some embodiments, the source of the magnetic field may be a permanent magnet that is positioned adjacent to the second surface. In some embodiments, the second surface may be a bottom surface of the microactuator, and the permanent magnet may be positioned beneath the second surface (e.g., adjacent to the second surface).

In some embodiments, applying the spot magnetic field may include activating a first electromagnet at a position proximate to the first location. In these embodiments, moving the spot magnetic field to separate the bead pallet from the main body of the droplet may include activating a second electromagnet at a position proximate to a second location.

In some embodiments, moving the spot magnetic field to separate the bead pallet from the main body of the droplet may include physically moving the source of the spot magnetic field.

In some embodiments, the microactuator may include a first substrate and a second substrate spaced apart from the first substrate to define a gap between the first substrate and the second substrate, wherein the droplet is disposed in the gap, and wherein the second substrate comprises a physical barrier extending into the gap configured to prevent or reduce an amount of the fluid egressing to a second location from the first location.

In some embodiments, the methods and devices may include or may be configured for applying a spot magnetic field to one or more magnetically responsive beads at a second location on a first surface of a microactuator; and moving the spot magnetic field to introduce one or more magnetically responsive beads into a droplet disposed on a first location, wherein the droplet includes a fluid.

In some embodiments, the spot magnetic field may be moved along a first direction (e.g., by moving a magnet in the first direction) and the main body of the droplet may be moved along a second direction that is different from the first direction (e.g., in a direction directly opposite to the first direction). For example, the spot magnetic field may be moved along the first direction and the main body of the droplet may be moved along the second direction simultaneously or near-simultaneously. Such a technique may be used to, for example, separate beads more quickly from droplets, or to introduce beads to droplets more quickly. In some embodiments, the main body of the droplet may be moved in the second direction using electrowetting. In some embodiments, the main body of the droplet is moved in the second direction by causing a portion of the main body of the droplet to contact a hydrophilic portion of the first surface. In some embodiments, a pressure differential may be used to move the main body of the droplet in the second direction. The main body of the droplet may be moved in the second direction using a pressure differential between a first side of the main body and a second side of the main body. For example, the microactuator may include a first substrate and a second substrate spaced apart from the first substrate to define a gap between the first substrate and the second substrate, wherein the droplet is disposed in the gap. In this example, the main body of the droplet may be moved in the second direction using a pressure differential caused by a change in volume of the gap in which the droplet is disposed on the microactuator.

This summary is provided to introduce the different embodiments of the present disclosure in a simplified form that are further described in detail below. This summary is not intended to be used to limit the scope of the claimed subject matter. Other features, details, utilities, and advantages of the claimed subject matter will be apparent from the following detailed description.

### BRIEF DESCRIPTION OF THE DRAWINGS

FIG. 1A is a schematic diagram illustrating an example of a microactuator.

FIG. 1B is a cross-sectional view of the microactuator shown in FIG. 1A taken along the line B-B′.

FIG. 2A is a cross-sectional view of a portion of another example of a microactuator.

FIG. 2B is a cross-sectional view of a portion of another example of a microactuator.

FIGS. 3A-3C illustrate examples of a droplet in a microactuator.

FIGS. 4A-4E illustrate an example of a microactuator using a magnetic field source to separate one or more beads from a droplet main body.

FIGS. 5A-5C illustrate an example of a microactuator having a series of magnetic field sources for manipulating beads.

FIG. 6 illustrates an example of a microactuator with a physical barrier for preventing or reducing fluid waste.

FIGS. 7A-7D illustrate one example of a microactuator moving a spot magnetic field to move one or more beads in a first direction and using electrowetting to move a droplet main body in a second direction.

FIGS. 8A-8D illustrate one example of a microactuator moving a spot magnetic field to move one or more beads in a first direction and using a hydrophilic surface to move a droplet main body in a second direction.

FIGS. 9A-9D illustrate one example of a microactuator moving a spot magnetic field to move one or more beads in a first direction and using a pressure differential to move a droplet main body in a second direction.

FIG. 10 illustrates an example method for magnetically separating one or more beads from a droplet main body on a microfluidics actuator.

FIG. 11 illustrates an example method for magnetically introducing one or more beads into a droplet main body on a microfluidics actuator.

In accordance with common practice, the described features and elements are not drawn to scale but are drawn to emphasize features and elements relevant to the present disclosure.

### DETAILED DESCRIPTION

In the following detailed description, reference is made to the accompanying drawings which form a part hereof, and in which is shown by way of illustration specific, non-limiting examples in which the invention may be implemented. The terms “upper,” “lower,” “vertical,” “height,” “top,” “bottom,” etc., are used with reference to the orientation of the figures being described. Because components of embodiments of the present invention can be positioned in a number of different orientations, the term is used for purposes of illustration and is not limiting.

Several of the figures schematically illustrate droplets in microactuators. In these examples, the droplets may be considered a liquid with boundaries formed at least in part by surface tension having a certain volume, e.g., between about several milliliters (10⁻³) to about several microliters (10⁻⁶). A droplet may be a water-based (aqueous) droplet including any organic or inorganic species such as, biological molecules, proteins, living or dead organisms, reagents, and any combination thereof. A droplet may be a non-aqueous liquid. A droplet may be spherical or non-spherical and have a size ranging from about 1 micrometer to several millimeters. In some embodiments, the droplet may have dimensions of 1×1×0.3 mm to 1.5×1.5×0.5 mm. In some embodiments, a droplet may be encapsulated by a filler fluid. A droplet may also include one or more beads.

Several of the figures schematically illustrate beads in microactuators. In these examples, the beads may be considered to be any particle capable of being manipulated on a microactuator, or of interacting with a droplet on or in proximity with a microactuator. Beads may be any of a wide variety of shapes, such as spherical, generally spherical, egg shaped, disc shaped, cubical and other three dimensional shapes.

In some embodiments, the beads may be magnetically responsive. In these embodiments, the beads may be capable of being manipulated (e.g., moved from a first location to a second location on a microactuator) by a magnetic field source. For example, a magnetically responsive bead may be attracted to or repelled by a magnetic field source. A bead may be made magnetically responsive by, for example, including magnetically responsive materials materials such as paramagnetic materials, ferromagnetic materials, ferrimagnetic materials, and/or metamagnetic materials.

In some embodiments, one or more reagents may be employed by a microactuator. In these embodiments, the reagents may be considered a substance used to induce or otherwise facilitate a reaction (e.g., with a species present in a droplet).

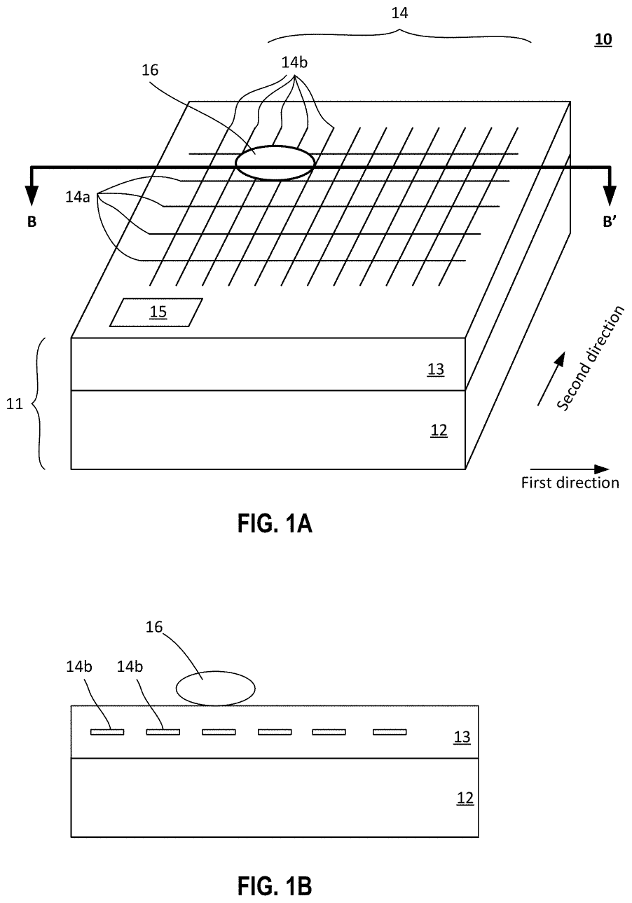

FIG. 1A is a schematic diagram illustrating an example of a microactuator 10. The illustrated microactuator of FIG. 1A is a microfluidics droplet actuator that is capable of manipulating droplets and/or particles (e.g., beads) along one or more substrates. The microactuator 10 includes a substrate structure 11 having a bottom substrate 12, an insulating layer 13 on the substrate, and an array of electrodes 14a and 14b within or under the insulating layer. The array of electrodes 14a and 14b may include a first set of electrodes 14a arranged in parallel to each other and spaced apart from each other in a first direction, and a second set of electrodes 14b arranged in parallel to each other and spaced apart from each in a second direction substantially perpendicular to the first direction. The first and second set of electrodes may be spaced apart from each other within the insulating layer 13, which may include a plurality of dielectric layers of the same material or different materials. The microactuator 10 may also include an input-output circuit 15 in the substrate and configured to interface with a control circuit (not shown in FIG. 1A) that may be integrated in the microactuator 10 or external to the microactuator 10 to provide control voltages having time-varying voltage waveforms to the array of electrodes 14a and 14b.

Referring to FIG. 1A, a liquid droplet 16 disposed on the surface of the insulating layer 13 may be moved on the surface by turning on/off control voltages (or by modulating voltage levels) at electrodes below the droplet and at adjacent electrodes.

FIG. 1B is a cross-sectional view of the microactuator 10 shown in FIG. 1A taken along the line B-B′. The cross sectional view of the second set of electrodes 14b is shown. The first set of electrodes 14a (not shown) may be disposed above, below, or in the same plane as the second set of electrodes 14b and spaced apart from the second set of electrodes by one or more dielectric layers.

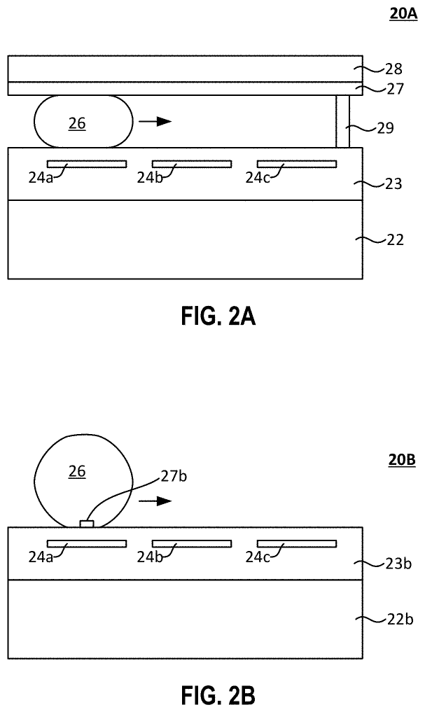

FIG. 2A is a cross-sectional view of a portion of another example of a microactuator 20A. Referring to FIG. 2A, the microactuator 20A includes a first substrate 22, a dielectric layer 23 on the substrate 21, a set of actuation electrodes 24a, 24b, and 24c within the dielectric layer 23, a common electrode 27 attached to a second substrate 28 and facing toward the actuation electrodes 24. In some embodiments, the common electrode 27 may be grounded or may be a reference electrode having some other common voltage. In some embodiments, the dielectric layer 23 and the common electrode 27 are spaced apart from each other by a spacer 29 to create a gap. In other embodiments, the gap may be formed by a sealant (e.g., glue or some other bonding agent) that secures the first substrate 22 to the second substrate 28, or in other manners.

Referring to FIG. 2A, two substrate structures may be separately formed. For example, a first substrate structure may be formed including the substrate 22, the dielectric layer 23, and the actuation electrodes 24a, 24b, and 24c within the dielectric layer 23. The substrate 22 may be a thin-film transistor (TFT) array substrate formed by conventional thin-film transistor manufacturing processes. A second substrate structure may include a substrate 28 and a common electrode layer 27 on the substrate 28. A spacer 29 may be formed either on the first substrate structure or the second substrate structure. In certain embodiments, the spacer 29 has a height in the range between several micrometers to several millimeters. In general, the height of the spacer 29 is less than the diameter of the droplets for which the microactuator is configured such that the droplet disposed on the dielectric layer 23 has physical contact with the second substrate structure. The first and second substrate structures are then bonded together to form the microactuator 20A. In other words, the space or air gap between the first substrate structure and the second substrate structure in this example is determined by the height or thickness of the spacer 29. The space or air gap forms a channel for the droplet.

In the example shown in FIG. 2A, the common electrode 27 and the set of actuation electrodes 24a, 24b, 24c are connected to voltages provided by a control circuit (not shown) through the input-output circuit 15 shown in FIG. 1A. The common electrode may be connected to a ground potential or a stable DC voltage. The control circuit applies time varying voltages through the input-output circuit to the set of actuation electrodes through respective electronic switches (that can be, e.g., thin film transistors or MOS circuitry in the substrate or off-chip) to generate an electric field across the droplet to move the droplet along a path. In some embodiments, the surface of the common electrode 27 is covered by an insulating layer made from a hydrophobic material. In other embodiments, the surface of the dielectric layer 23 is coated with a thin hydrophobic film having a submicron thickness.

Referring to FIG. 2A, a droplet 26 may be disposed between the first substrate 22 and the second substrate 28 (and consequently between the actuation electrodes 24a, 24b, and 24c and the common electrode 27). In an embodiment, the microactuator 20A may further include a control circuit (not shown) configured to provide control voltages to the common electrode 27 and the actuation electrodes 24. The droplet 26 may be moved along a lateral direction across the surface of the dielectric layer 23 by changing or varying the voltage levels applied to the actuation electrodes in relation to the common electrode. Applying a voltage (or increasing a voltage level) in this manner to a particular actuation electrode may have the effect of reducing hydrophobicity (i.e., increasing the hydrophilicity) of a portion of the first substrate 22 immediately around the location of the particular actuation electrode. This effect is commonly known as electrowetting (or more specifically, electrowetting on dielectric (EWOD) when the electrowetting occurs on a dielectric), and it can be used to move a droplet across a surface. By turning on and off voltages applied to the actuation electrodes, the control circuit can move the liquid droplet 26 in a lateral direction across the surface of the dielectric layer 23. For example, an electric field is generated by applying a first voltage to the actuation electrode 24a below the droplet 26 and a second voltage to the adjacent actuation electrode 24b, the generated electric field causes the droplet 26 to move toward the actuation electrode 24b. The speed of the droplet 26 can be controlled by the magnitude of a voltage difference between the adjacent actuation electrodes. In one embodiment, the form of the liquid droplet 26 can be changed by varying the voltage difference between the actuation electrodes 24a, 24b, and 24c and the common electrode 27 where the droplet 26 is disposed therebetween. It is understood that the number of actuation electrodes in the set of actuation electrodes can be any integer number. In the example shown in FIG. 2A, three actuation electrodes are used in the set of actuation electrodes. But it is understood that the number is arbitrarily chosen for describing the example embodiment and should not be limiting.

FIG. 2B is a cross-sectional view of a portion of another example of a microactuator. Referring to FIG. 2B, the microactuator 20B includes a substrate 22b, a dielectric layer 23b on the substrate 21b, a set of actuation electrodes 24a, 24b, and 24c within the dielectric layer 23b, and a set of common electrodes 27 (only one electrode 27b is shown) overlying the dielectric layer 23b. The common electrode 27b and the actuation electrodes are spaced apart from each other by a portion of the dielectric layer. Similar to FIG. 2A, the droplet 26 can be moved along a path in the lateral direction across the surface of the dielectric layer 23b by applying a first voltage at the actuation electrode (e.g., 24a) below the droplet 26 and a second voltage at the adjacent actuation electrode (e.g., 24b). The movement and direction of the droplet 26 is thus controlled by the control circuit (not shown) which applies voltages to certain actuation electrodes through a set of electronic switches (MOS circuitry in the substrate 22b, not shown). Different to the microactuator 20A shown in FIG. 20A, the microactuator 20B has the common electrode 27b close to the actuation electrodes 24, and the droplet 26 is not sandwiched between the common electrode 27 and the actuation electrodes 24. The microactuator 20B also differs from the microactuator 20A by not having the spacer 29.

Referring to FIG. 2B, the set of actuation electrodes 24a, 24b, and 24c and the set of common electrodes 27 may be two layers of strip electrodes intersected with each other on different planes on the substrate. The actuation electrodes 24a, 24b, and 24c and the common electrodes 27 are operative to move the droplet 26 across the surface of the dielectric layer 23b. In some embodiments, the common electrode 27b has a surface that is covered by an insulating layer made from a hydrophobic material. In other embodiments, the surface of the dielectric layer 23 is coated with a thin hydrophobic film having a submicron thickness.

An example of how the microactuators of FIGS. 1 and 2 may be used is the manipulation of a large number of droplets having a uniform or similar size as part of a droplet digital PCR on a microfluidic chip. With a small volume of each sample and below certain DNA concentration meeting the Poisson distribution requirement, each sample of the droplet may have either one DNA molecule or no DNA molecule. By thermo-cycling the samples with a conventional PCR or incubating them under a certain temperature with an isothermal PCR, a single DNA molecule within a target region can be amplified on each sample within the environment (e.g., oil). After reading the final droplet's DNA concentration by optical detection or pH measurement through integrated on-chip ion-sensitive field-effect transistor (ISFET) sensors, the absolute numbers of a targeted DNA in the array of samples may be quantified and then use the absolute DNA quantification to calculate the DNA concentration in the bulk droplet. In some instances, a droplet containing multiple different DNA targets can be dispensed on a region of a single microfluidic chip, the droplet is then moved by electrowetting to a next region which produces a multitude of samples (copies of the DNA targets) from the droplet for detection or measurement of the samples.

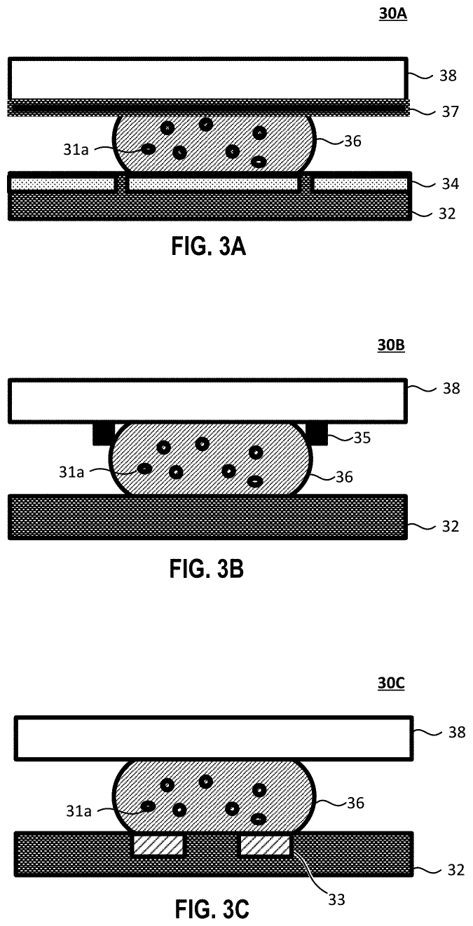

FIGS. 3-6 show examples of microactuators in which targets such as DNA molecules are bound to magnetically responsive beads. By binding targets to a magnetically responsive bead, the targets may be moved to desired locations or otherwise manipulated on a microactuator. For example, DNA molecules bound to one or more magnetically responsive beads may be moved from one location to another location on a microactuator by controlling a magnetic field generated by a source.

In some instances, magnetically responsive beads may be moved into or out of droplets containing one or more reagents to effectuate appropriate reactions with the targets bound to the magnetically responsive beads. For example, a magnetically responsive bead bound to single-stranded DNA molecules may be introduced into a droplet containing a suitable polymerize and/or nucleotides to initiate PCR. In some embodiments, magnetically responsive beads may be “washed” once a target has been eluted from the magnetically responsive beads. For example, after desired reactions have occurred with respect to DNA molecules on one or more magnetically responsive beads within a first droplet, the magnetically responsive beads may be moved from the first droplet to a second droplet that causes the DNA molecules to be released from the magnetically responsive beads. The magnetically responsive beads may then be moved from the first droplet to a third droplet that includes a buffer solution to wash the magnetically responsive beads. Finally, the washed magnetically responsive beads may be moved out of the third droplet, and may be reused again within the microactuator as desired (e.g., by introducing it to a fourth droplet that includes DNA molecules and an enzyme capable of binding the DNA molecules to the magnetically responsive beads). In some instances, magnetically responsive beads may be moved (e.g., magnetically) into or out of particular zones on a microactuator. For example, magnetically responsive beads containing DNA may be moved from a first zone with a first temperature to a second zone with a second temperature. In some instances, magnetically responsive beads may be moved (e.g., magnetically) into or out of inlets or outlets on a microactuator.

FIGS. 3A-3C show an example of a droplet including a set of beads positioned on a position on a microactuator and temporarily held in that position. In some embodiments, the droplet may be moved to and held in its position using the electrowetting principles discussed herein by operating the actuating electrodes 34. For example, referencing FIG. 3A, the droplet 36 which includes a plurality of beads 31a may be disposed within a gap of a microactuator 30A. In some embodiments, as illustrated, the microactuator 30A may include a common electrode 37 and one or more actuation electrodes 34. In these embodiments, the gap may be formed by a first substrate 32 and the common electrode 37. Both the common electrode 37 and the first substrate 32 may be hydrophobic, to allow for a relatively large contact angle. The droplet 36 may be held in position using this hydrophobicity. In particular embodiments, the actuation electrodes 34 may be encased within the first substrate 32, which may be a dielectric. As another example, referencing FIG. 3B, the droplet 36 may be held in place within the microactuator 30B using physical barriers 35 that extend at least partially into a gap in which the droplet 36 sits, the gap being formed by the first substrate 32 and the second substrate 38. For example, as illustrated in FIG. 3B, there may be two physical barriers 35 disposed on opposite ends of the droplet 36. In some embodiments, the physical barriers may be a narrowing of the gap, a discrete projection protruding into the gap, or a combination thereof. As another example, referencing FIG. 3C, the droplet 36 may be held within the microactuator 30C using hydrophilic patches 33 mounted on the substrate 32, which may be hydrophobic. In this example, the droplet 36 may be attracted to the hydrophobic patches 33 and repelled by the hydrophobic substrate 32 such that the droplet is held in place.

In some embodiments, the beads may be magnetically responsive such that they may be moved or otherwise manipulated using a magnetic field source. In some embodiments, one or more beads may include only a single bead (e.g., one “super bead”). In some embodiments, the one or more beads may include a set of beads (e.g., two or more beads).

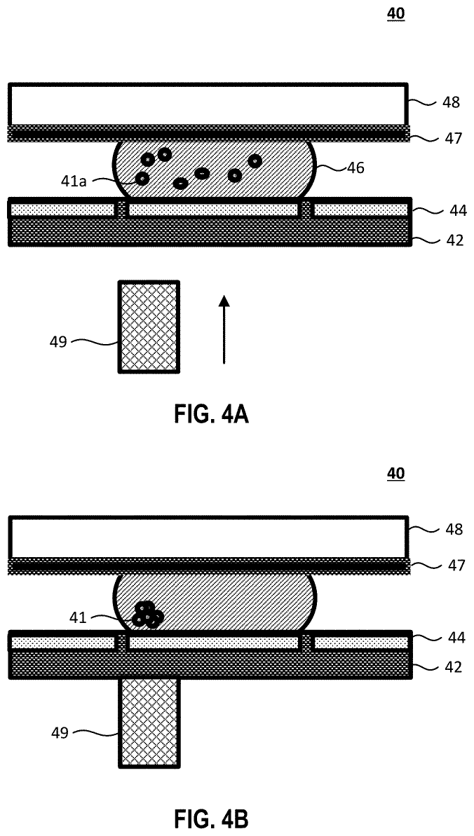

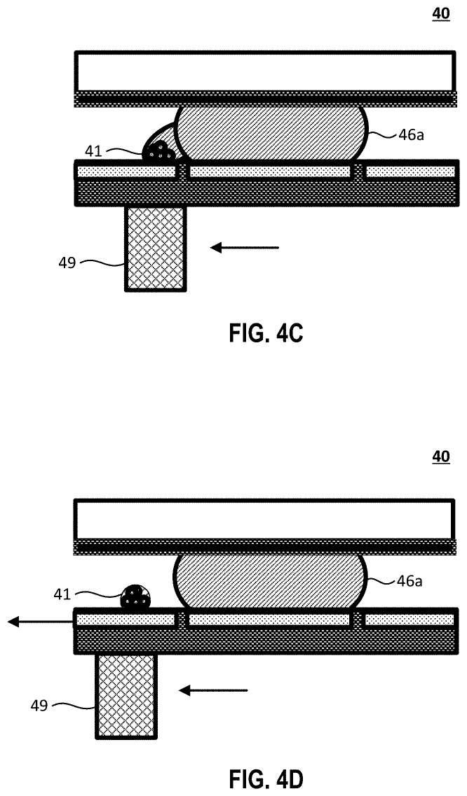

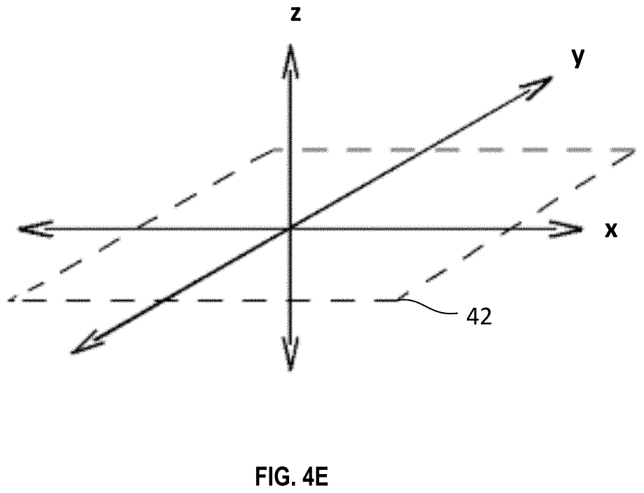

FIGS. 4A-4E illustrate an example of a microactuator 40 using a magnetic field source 49 to separate one or more beads from a droplet main body 46a. The microactuator 40 may include a first substrate 42 (e.g., a top substrate) and an opposing second substrate 48 (e.g., a bottom substrate) in some embodiments, the microactuator 40 may be configured to employ the electrowetting principles discussed herein, and may include a common electrode 47 mounted to the second substrate 48 and one or more actuation electrodes 44 encased within or mounted to the first substrate 42. In some embodiments, one or more magnetic fields may be used to separate one or more beads from a droplet 46 on a microactuator. In some embodiments, a spot (or localized) magnetic field may be applied to a droplet disposed at a first location on a first surface of a microactuator. The droplet may include one or more beads and a fluid. The microactuator 40 may include a magnet 49 (e.g., a permanent magnet, an electromagnet) as a magnetic field source for emitting the spot magnetic field. In some embodiments, the magnet 49 may be positioned under the first substrate 42. As an example, the magnet 49 may be a permanent magnet with a diameter of 1/16 inches. Although this disclosure describes a configuration where the magnet 49 is positioned under the first substrate 42, the disclosure contemplates that the magnet 49 may alternatively be positioned above the second substrate 48.

In some embodiments, the spot magnetic field may be moved toward the first location, where a droplet is disposed, thereby causing magnetically responsive beads within the droplet to be attracted toward the source of the spot magnetic field. In some embodiments, moving the spot magnetic field may include moving the source of the spot magnetic field. For example, as illustrated in FIG. 4A, the spot magnetic field may be moved toward the first location by moving the magnet 49 from an initial position that is removed from the first substrate 42 toward a position that is proximate to the first substrate 42. The magnet 49 may also have been moved in the lateral direction (not shown in FIG. 4A) such that it is near the first location. This mobility may be afforded to the magnet 49 by, for example, coupling the magnet 49 to an X-Y-Z linear motor that is capable of moving the magnet in three dimensions. In this example, the magnet 49 may be moved laterally along a vector that is substantially parallel to an X-Y plane defined by the surface 42 and/or vertically along a vector in the Z direction that is perpendicular to the X-Y plane defined by the surface 42. FIG. 4A illustrates moving the magnet 49 in a Z direction. In some embodiments, the magnet 49 may be moved both laterally and vertically along a single trajectory defined by a vector having vector components both parallel to and perpendicular to the X-Y plane defined by the surface 42. For example, such a vector may have a terminal point in an X-Y-Z coordinate system of (1, −2, 3), with an initial point (0, 0, 0) being located at a suitable location (e.g., beneath the surface 42). Purely for illustrative purposes, FIG. 4E illustrates an X-Y-Z coordinate system, with the X-Y plane defined by the surface 42.

In some instances, a spot magnetic field may be moved so as to separate the one or more magnetically responsive beads from a main body of the droplet. In some embodiments, as illustrated in FIG. 4B, when there is a plurality of beads, applying the spot magnetic field to the droplet may concentrate a set of beads (when there is a plurality) into a “bead pallet,” which is a term that may refer to a body that includes an aggregate or cluster of two or more beads. As illustrated in FIG. 4B, when the magnet 49 is brought in close proximity to the beads 41a, the magnet 49 exerts a spot magnetic field on the beads 41a the causes the beads 41a to be aggregated into the bead pallet 41. As illustrated in FIG. 4C, in some embodiments, the magnet 49 may be moved laterally such that the bead pallet 41 is caused to move along with the magnet 49 toward a second location on the first surface of the microactuator. In these embodiments, the droplet 46 may be held relatively stationary and may remain in its initial position at the first location. As illustrated in FIG. 4D, the magnet 49 may continue to be moved laterally, resulting in the bead pallet 41 being pinched off and ultimately separated from the droplet main body 46a. In some embodiments, a residual number of beads may be left behind. However, as discussed previously herein, the methods and systems disclosed herein minimize the number of residual beads as compared to more conventional techniques.

In some embodiments, one or more magnetic fields may be used to introduce one or more beads into a droplet main body on a microactuator. This may be achieved by, for example, performing the steps discussed with respect to FIGS. 4A-4D in reverse. For example, a magnet 49 may be moved toward one or more magnetically responsive beads disposed at a second location on a first surface of a microactuator, to produce a spot magnetic field such that magnetically responsive beads are attracted toward the magnet 49 and aggregated into a bead pallet 41. The spot magnetic field may be moved to a first location at which a droplet is disposed introduce the magnetically responsive beads into the droplet (e.g., by moving the magnet 49 laterally toward the droplet).

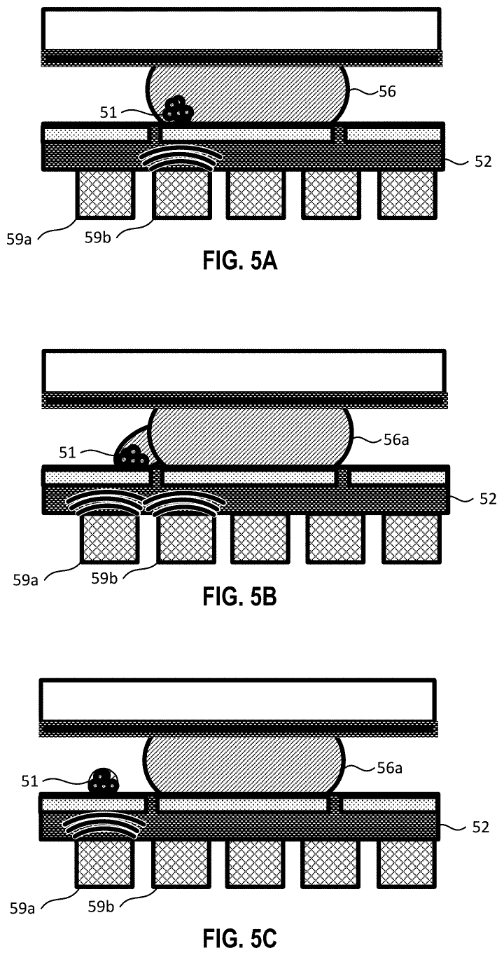

FIGS. 5A-5C illustrate an example of a microactuator having a series of magnetic field sources for manipulating beads. In some embodiments, a microactuator may use a plurality of stationary magnetic field sources to move or otherwise manipulate one or more magnetically responsive beads. The stationary magnetic field sources may be, for example, electromagnets that may be turned on or off (or may be electromagnets whose magnetic field strength may be modulated). Referencing FIG. 5A, magnetic beads within the droplet 56 may be aggregated into a bead pallet 51 by activating the magnet 59b, which may be located beneath (e.g., adjacent to) the first substrate 52. As illustrated, the magnet 59b is located proximate to the droplet 56. Referencing FIG. 5B, the magnet 59b may then be activated to begin moving the bead pallet 51 away from the droplet main body 56a, while the droplet main body remains relatively stationary. As illustrated in FIG. 5C, the magnet 59B may be deactivated while the magnet 59a remains activated, completing separation of the bead pallet 51 from the droplet main body 56a. In some embodiments, this process may occur in reverse to introduce a bead pallet into a droplet.

In some embodiments, the bead pallet (or a bead) may also include a small or residual volume of fluid. This residual volume of fluid may simply be a remnant of fluid from a droplet (e.g., a droplet within which the beads may have been at some point). In some embodiments, it may be desirable to reduce or eliminate the residual volume of fluid from a bead pallet. This may be advantageous to reduce fluid waste. For example, a bead pallet separated from a reagent droplet may include a residual volume of the reagent that may have egressed with the bead pallet. In this example, before beads of the bead pallet may be used again, the residual volume of the reagent may need to be washed away (e.g., by introducing the bead pallet into a buffer droplet). Alternatively, the beads may need to be discarded. In either case, the result is an unnecessary waste of reagent. Consequently, the quantity of reagent may be diminished over time with each introduction and separation of the beads from droplets of the reagent, requiring larger amounts of reagent than necessary for prescribed reactions.

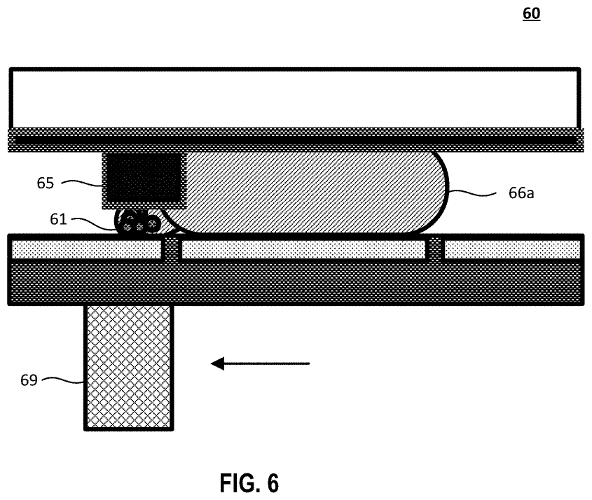

FIG. 6 illustrates an example of a microactuator with a physical barrier for preventing or reducing fluid waste. In some embodiments, a microactuator may include one or more physical barriers that prevent or reduce the egress of residual volumes of fluid when a bead pallet (or a bead) is removed. For example, referencing FIG. 6, the microactuator 60 may include the physical barrier 65, which may extend partially into the gap (and thereby narrowing the gap) in which a droplet is disposed. As illustrated, when the magnet 69 is moved to the left of the physical barrier 65, the physical barrier 65 may permit the bead pallet 61 to be moved to the left of the physical barriers 65, but may serve to block or reduce a residual volume of fluid that may egress along with the bead pallet 61. Consequently, a larger amount of fluid may be retained in the droplet main body 66a.

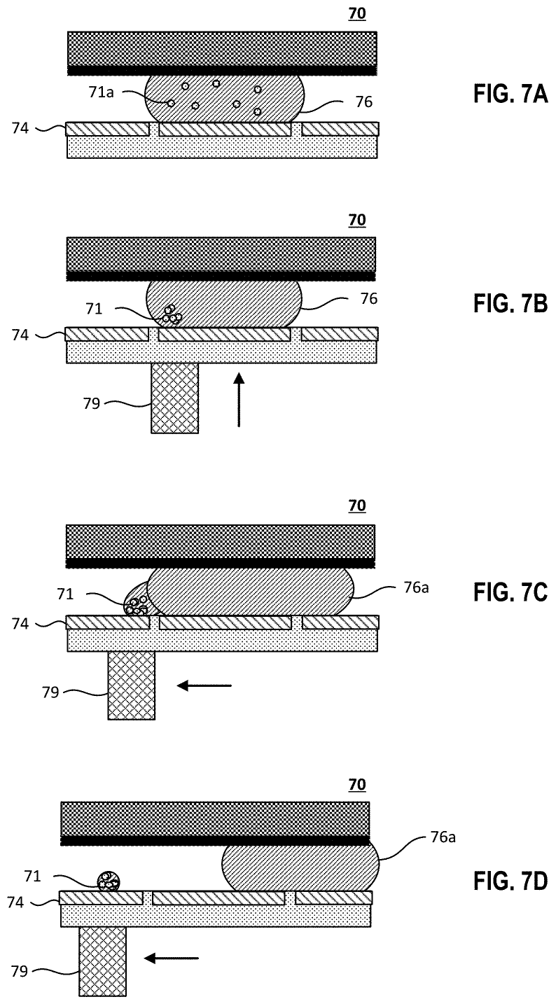

In some cases, faster separation of beads from droplets (or alternatively, faster introduction of beads to droplets) may be optimal. In such cases, it may be advantageous to not only move the beads, but to also move the droplet main body and thereby reduce the time it takes to separate (or introduce) beads from (or to) a droplet. Example techniques for accomplishing this are described below with respect to FIGS. 7A-9D.

FIGS. 7A-7D illustrate one example of a microactuator 70 moving a spot magnetic field to move one or more beads 71a in a first direction and using electrowetting to move a droplet main body 76a in a second direction. As illustrated in FIG. 7A, a droplet 76 including beads 71a may be disposed on a surface of the microactuator 70 having a plurality of actuation electrodes 74. As illustrated in FIG. 7B, a magnet 79 may be moved toward a substrate of the microactuator 70 to aggregate the beads 71a into a bead pallet 71. As illustrated in FIG. 7C, the magnet 79 may be moved in a first direction (here, to the left of the figure) to cause the bead pallet 71 to also move in the first direction. Simultaneously or near-simultaneously, the actuation electrodes 74 may be activated so as to move the droplet main body 76a in a second direction (here, to the right of the figure) using electrowetting principles as described elsewhere herein. FIG. 7D illustrates a final separation, yielding the separated bead pallet 71 and the droplet main body 76a.

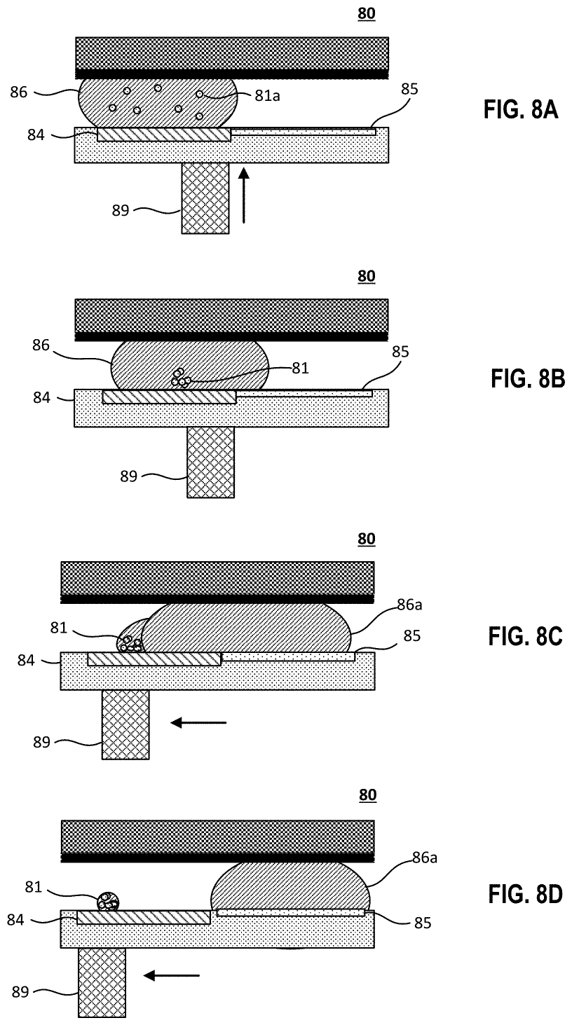

FIGS. 8A-8D illustrate one example of a microactuator 80 moving a spot magnetic field to move one or more beads 81a in a first direction and using a hydrophilic surface 85 to move a droplet main body 86a in a second direction. As illustrated in FIG. 8A, a droplet 86 including beads 81a may be disposed on a surface of the microactuator 80. As illustrated in FIG. 8A, a magnet 89 may be brought toward a substrate of the microactuator 80 to aggregate the beads 81a into a bead pallet 81 as illustrated in FIG. 8B. Also as illustrated in FIG. 8B, at least a portion of the droplet 86 may be caused to contact the hydrophilic surface 85 (e.g., a hydrophilic patch). For example, electrowetting by operation of the actuation electrode 84 may be used to move the droplet 86 toward the hydrophilic surface 85 until the portion of the droplet 86 contacts the hydrophilic surface 85. As illustrated in FIG. 8C, the magnet 89 may be moved in a first direction to cause the bead pallet 81 to also move in the first direction. Also as illustrated in FIG. 8C, simultaneously or near-simultaneously, the hydrophilicity of the hydrophilic surface 85 may cause the droplet main body 86a to move toward a second direction. In this step or immediately before this step, the actuation electrode 84 may be optionally turned off such that the droplet main body 86a may no longer be attracted to the substrate portion near the actuation electrode 84 (e.g., without the actuation electrode 84 being on, this portion may become hydrophobic again). FIG. 8D illustrates a final separation, yielding the separated bead pallet 81 and the droplet main body 86a.

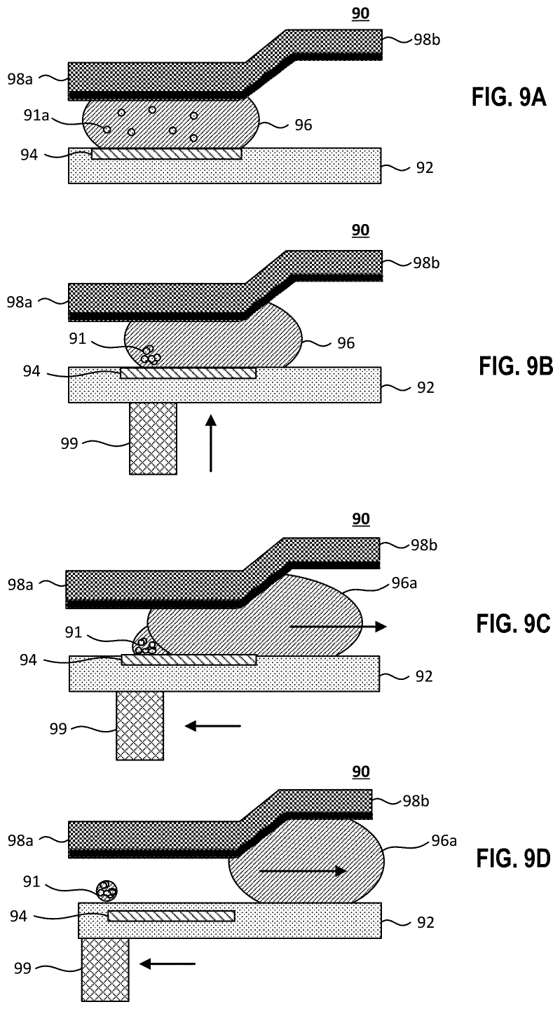

FIGS. 9A-9D illustrate one example of a microactuator 90 moving a spot magnetic field to move one or more beads 91a in a first direction and using a pressure differential to move a droplet main body 86a in a second direction. As illustrated in FIG. 9A, the microactuator 90 may include a first substrate 92 and a second substrate with two portions, 98a and 98b, being of varying distances from the first substrate 92. In the illustrated example, the portion 98a is closer to the first substrate 92 than the portion 98b. As a result, the volume of the gap between the substrates of the microactuator 90 along the portion 98a is smaller than the volume of the corresponding gap along the portion 98b. This difference in volume creates a pressure differential within the gap along the two portions. For example, per Boyle's law, P1V1=P2V2, ensuring that an increased volume along the portion 98b relative to the portion 98a must translate to a decreased pressure (all else equal) along the portion 98b relative to the portion 98a. This pressure differential create a capillary pressure force in the second direction (e.g., to the right of the figure). As illustrated in FIG. 9A, the droplet 96 may be brought near a juncture between the portion 98a and the portion 98b (e.g., using electrowetting with the actuation electrode 94). As illustrated in FIG. 9B, a magnet 96 may be brought toward the first substrate of the microactuator 90 to aggregate the beads 91a into a bead pallet 91. As illustrated in FIG. 9C, the magnet 99 may be moved in a first direction because the bead pallet 91 to also move in the first direction. Also as illustrated in FIG. 9C, simultaneously or near-simultaneously, the droplet main body 96a may be caused to move in the second direction due to the pressure differential between the gap along the portions 98a and 98b (e.g., in FIG. 9C, the left side of the droplet main body 96a may experience a higher pressure than the right side of the droplet main body 96a, thereby propelling the droplet main body 96a to the right). In this step or immediately before this step, the actuation electrode 94 may be optionally turned off such that the droplet main body 96a may no longer be attracted to the substrate portion near the actuation electrode 94 (e.g., without the actuation electrode 94 being on, this portion may become hydrophobic again). FIG. 9D illustrates a final separation, yielding the separated bead pallet 91 and the droplet main body 96a. In some embodiments, the pressure differential may be created by applying active positive pressure or active negative pressure (e.g., via a vacuum source).

Although FIGS. 7A-9D illustrate the use of a single movable magnet, this disclosure contemplates the use of multiple non-movable magnets as illustrated in FIGS. 5A-5C. Furthermore, although FIGS. 7A-9D illustrate the first direction (e.g., left) being in direct opposition to the second direction (e.g., right), this disclosure contemplates circumstances where the first direction is different from the second direction but not in direct opposition (e.g., the first direction may be a direction that is perpendicular to the second direction, or at an acute or obtuse angle).

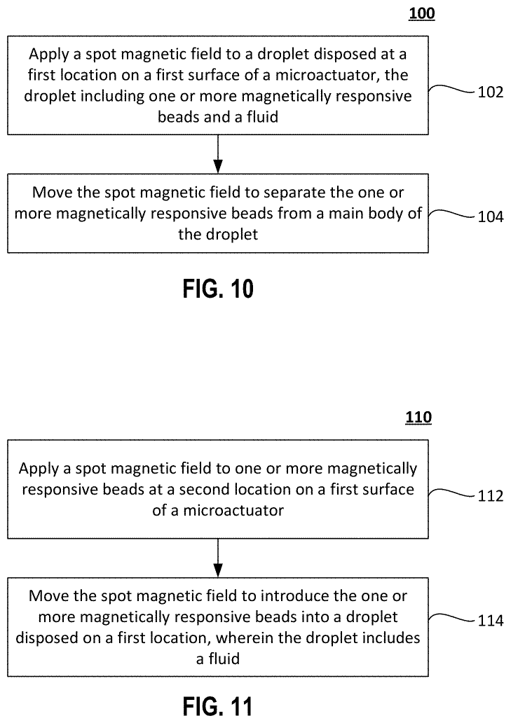

FIG. 10 illustrates an example method 100 for magnetically separating one or more beads from a droplet main body on a microfluidics actuator. The method may begin at step 102, where a spot magnetic field may be applied to a droplet disposed at a first location on a first surface of a microactuator, the droplet including one or more magnetically responsive beads and a fluid. At step 104, the spot magnetic field may be moved to separate the magnetically responsive beads from a main body of the droplet. Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for magnetically separating one or more beads from a droplet main body on a microfluidics actuator, including the particular steps of the method of FIG. 10, this disclosure contemplates any suitable method for magnetically separating one or more beads from a droplet main body on a microfluidics actuator including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

FIG. 11 illustrates an example method 110 for magnetically introducing one or more beads into a droplet main body on a microfluidics actuator. The method may begin at step 112, where a spot magnetic field may be applied to one or more magnetically responsive beads at a second location on a first surface of a microactuator. At step 114, the spot magnetic field may be moved to introduce the magnetically responsive beads into a droplet disposed on a first location, wherein the droplet includes a fluid. Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for magnetically introducing one or more beads into a droplet main body on a microfluidics actuator, including the particular steps of the method of FIG. 11, this disclosure contemplates any suitable method for magnetically introducing one or more beads into a droplet main body on a microfluidics actuator including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

Although the processes described herein are described with respect to a certain number of steps being performed in a certain order, it is contemplated that additional steps may be included that are not explicitly shown and/or described. Further, it is contemplated that fewer steps than those shown and described may be included without departing from the scope of the described embodiments (i.e., one or some of the described steps may be optional). In addition, it is contemplated that the steps described herein may be performed in a different order than that described.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

For all flowcharts herein, it will be understood that many of the steps can be combined, performed in parallel or performed in a different sequence without affecting the functions achieved.

1. A method for magnetically separating one or more beads from a droplet main body on a microfluidics actuator, the method comprising:
applying a spot magnetic field to a droplet disposed at a first location on a first surface of a microactuator, the droplet including one or more magnetically responsive beads and a fluid; and
moving the spot magnetic field to separate the one or more magnetically responsive beads from a main body of the droplet.

2. The method of claim 1, wherein the one or more magnetically responsive beads comprises a set of magnetically responsive beads, and wherein applying the spot magnetic field to the droplet concentrates at least some of the set of magnetically responsive beads into a bead pallet, and wherein moving the spot magnetic field comprises separating the bead pallet from the main body of the droplet.

3. The method of claim 2, wherein applying the spot magnetic field to the droplet comprises moving a source of the spot magnetic field toward the first location.

4. The method of claim 3, wherein moving the spot magnetic field to separate the bead pallet from the main body of the droplet comprises moving the source of the spot magnetic field along the first surface of the microactuator, and wherein moving the spot magnetic field moves the bead pallet to a second location on the first surface.

5. (canceled)

6. The method of claim 5, wherein the microactuator comprises a first substrate, wherein the first substrate comprises the first surface and a second surface that opposes the first surface, and wherein the permanent magnet is positioned adjacent to the second surface.

7. The method of claim 2, wherein applying the spot magnetic field comprises activating a first electromagnet at a position proximate to the first location, and wherein moving the spot magnetic field to separate the bead pallet from the main body of the droplet comprises activating a second electromagnet at a position proximate to a second location.

8. The method of claim 2, wherein moving the spot magnetic field to separate the bead pallet from the main body of the droplet comprises physically moving a source of the spot magnetic field.

9. The method of claim 2, wherein the bead pallet further comprises a residual volume of the fluid.

10. The method of claim 2, wherein the microactuator comprises a first substrate and a second substrate spaced apart from the first substrate to define a gap between the first substrate and the second substrate, wherein the droplet is disposed in the gap, and wherein the second substrate comprises a physical barrier extending into the gap configured to prevent or reduce an amount of the fluid egressing to a second location from the first location.

11. The method of claim 1, wherein separating the one or more magnetically responsive beads from the main body of the droplet comprises both moving the spot magnetic field along a first direction and moving the main body of the droplet along a second direction that is different from the first direction.

12. The method of claim 11, wherein the main body of the droplet is moved in the second direction using electrowetting.

13. The method of claim 11, wherein the main body of the droplet is moved in the second direction by causing a portion of the main body of the droplet to contact a hydrophilic portion of the first surface.

14. The method of claim 11, wherein the main body of the droplet is moved in the second direction using a pressure differential between a first side of the main body and a second side of the main body

15. The method of claim 14, wherein:
the microactuator comprises a first substrate and a second substrate spaced apart from the first substrate to define a gap between the first substrate and the second substrate, wherein the droplet is disposed in the gap, and
wherein the pressure differential is caused by a change in volume of the gap in which the droplet is disposed on the microactuator.

16. A method for magnetically introducing one or more beads into a droplet main body on a microfluidics actuator, the method comprising:
applying a spot magnetic field to one or more magnetically responsive beads at a second location on a first surface of a microactuator; and
moving the spot magnetic field to introduce the one or more magnetically responsive beads into a droplet disposed on a first location, wherein the droplet includes a fluid.

17. The method of claim 16, wherein the one or more magnetically responsive beads comprises a set of magnetically responsive beads, and wherein applying the spot magnetic field to the set of magnetically responsive beads concentrates the set of magnetically responsive beads into a bead pallet, and wherein moving the spot magnetic field comprises introducing the bead pallet to a main body of the droplet.

18-30. (canceled)

31. A droplet microactuator comprising:
a first substrate having a first surface configured to receive one or more droplets and a second surface that opposes the first surface; and
a source of a magnetic field;
wherein the droplet microactuator is configured to:
apply a spot magnetic field to a first droplet disposed at a first location on a first surface of the droplet microactuator, the first droplet including one or more magnetically responsive beads and a fluid; and
move the spot magnetic field to separate the one or more magnetically responsive beads from a main body of the first droplet.

32. The droplet microactuator of claim 31, wherein the one or more magnetically responsive beads comprises a set of magnetically responsive beads, and wherein the droplet microactuator is configured to apply the spot magnetic field to the first droplet to concentrate the set of magnetically responsive beads into a bead pallet, and wherein the droplet microactuator is configured to move the spot magnetic field to separate the bead pallet from the main body of the first droplet.

33. The droplet microactuator of claim 32, wherein the droplet microactuator is configured to apply the spot magnetic field to the first droplet by moving a source of the spot magnetic field toward the first location, wherein the droplet microactuator is configured to move the spot magnetic field by moving the source of the spot magnetic field along the first surface of the droplet microactuator.

34-36. (canceled)

37. The droplet microactuator of claim 32, wherein the source of the spot magnetic field is an electromagnet, and wherein introducing the first droplet to the spot magnetic field comprises activating the electromagnet at a position near the first location.

38. The droplet microactuator of claim 32, wherein the droplet microactuator further comprises a second substrate spaced apart from the first substrate to define a gap between the first substrate and the second substrate, wherein the first droplet is disposed in the gap, and wherein the second substrate comprises a physical barrier extending into the gap configured to prevent or reduce an amount of the fluid from being transported to a second location from the first location.

39. The droplet microactuator of claim 31, wherein the droplet microactuator is configured to separate the one or more magnetically responsive beads from the main body of the first droplet by both moving the spot magnetic field along a first direction and moving the main body of the first droplet along a second direction that is different from the first direction.

40-43. (canceled)

44. A droplet microactuator comprising:
a first substrate having a first surface and a second surface that opposes the first surface;
a second substrate spaced apart from the first substrate to define a gap between the second substrate and the first substrate, wherein the gap is configured to allow a droplet to be disposed therein at a first location; and
a magnetic field source disposed underneath the first substrate;
wherein the magnetic field source is movable both (1) toward and away from the first substrate and (2) along the first substrate.

45. The droplet microactuator of claim 44, wherein the magnetic field source is movable along a trajectory defined at least in part by a vector perpendicular to a plane defined by the first substrate and further movable along a trajectory defined at least in part by a vector parallel to the plane defined by the first substrate.

46-53. (canceled)
